(19) United States
(12) Patent Application Publication
(10) Pub. No.: US 2026/0066472 A1
(43) Pub. Date: Mar. 5, 2026

(54) BATTERY CASE AND SECONDARY BATTERY INCLUDING SAME

(71) Applicant: SAMSUNG SDI CO., LTD., Yongin-Si (KR)

(72) Inventors: Soo-Mi EO, Yongin-Si (KR); Jeawoan LEE, Yongin-Si (KR)

(21) Appl. No.: 19/229,983

(22) Filed: Jun. 5, 2025

(30) Foreign Application Priority Data
Sep. 5, 2024 (KR) 10-2024-0120577

(51) Int. Cl. H01M 50/474; H01M 50/105; H01M 50/119; H01M 50/186; H01M 50/477; H01M 50/55; H01M 50/557; H01M 50/566

(52) U.S. Cl. CPC H01M 50/474; H01M 50/105; H01M 50/119; H01M 50/186; H01M 50/477; H01M 50/55; H01M 50/557; H01M 50/566

(57) ABSTRACT

A case may include a case body having an accommodation space and a first through-hole in a first wall of the case body, a first insulating member on an inner surface of the first wall, a terminal plate on the first insulating member, a rivet terminal penetrating the first through-hole of the case body, the first insulating member, and the terminal plate, and an electrode terminal connected to the rivet terminal on an outer surface of the first wall. The first insulating member may include a horizontal portion on the inner surface of the first wall, and a first extension portion extending from one side of the horizontal portion. 4904-4113-1563, v. 3

### CROSS-REFERENCE TO RELATED APPLICATION

The present application claims priority to and the benefit of Korean Patent Application No. 10-2024-0120577, filed on Sep. 5, 2024, in the Korean Intellectual Property Office, the entire disclosure of which is incorporated herein by reference.

### BACKGROUND

### 1. Field The present disclosure relates to a battery case and secondary battery including same.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

A pouch-type secondary battery of the related art has a case made of a material in which a metal film is thinly stacked between polymer layers. After the pouch-type secondary battery is attached to an electronic device, problems such as deformation of the case due to ductility of the polymer layers may occur in a procedure of replacing or detaching the secondary battery. To solve these problems, a secondary battery including a case made of a metal material is proposed.

In the secondary battery having such a structure, a negative electrode tab of an electrode assembly may be connected to the case, and a positive electrode tab of the electrode assembly may be connected to a terminal plate in the case. In this example, there is a possibility of an electrical short circuit occurring between the positive electrode tab and the case functioning as a negative electrode, and it is desirable to prevent such an electrical short circuit.

The above information disclosed in this Background section is for enhancement of understanding of the background of the present disclosure, and therefore, it may contain information that does not constitute related (or prior) art.

### SUMMARY

An object of the present disclosure is to provide a battery case and a secondary battery including a battery case for resolving the above problems.

However, the technical problem to be solved by the present disclosure is not limited to the above problem, and other problems not mentioned herein, and aspects and features of the present disclosure that would address such problems, will be clearly understood by those skilled in the art from the description of the present disclosure below.

According to an embodiment of the present disclosure to solve the above technical problem, a case may include a case body having an accommodation space and a first through-hole in a first wall of the case body, a first insulating member on an inner surface of the first wall, a terminal plate on the first insulating member, a rivet terminal penetrating the first through-hole of the case body, the first insulating member, and the terminal plate, and an electrode terminal connected to the rivet terminal on an outer surface of the first wall. The first insulating member may include a horizontal portion on the inner surface of the first wall, and a first extension portion extending from one side of the horizontal portion.

According to one or more embodiments, the first extension portion may extend in a direction substantially parallel to a second wall of the case body substantially perpendicular to the first wall.

According to one or more embodiments, the first extension portion may be higher than a height at which the terminal plate is on the horizontal portion.

According to one or more embodiments, the first extension portion may extend to be higher than a height of an electrode tab connected to the terminal plate.

According to one or more embodiments, the first insulating member may further include a second extension portion that extends from one side of the first extension portion in a direction intersecting a direction in which the first extension portion extends.

According to one or more embodiments, a width of the first insulating member may be longer than a width of the terminal plate in a direction corresponding to a long side of the first wall.

According to one or more embodiments, the case may further include a second insulating member between the first insulating member and a second wall of the case body that is substantially perpendicular to the first wall.

According to one or more embodiments, the second insulating member may be in one region of the second wall.

According to one or more embodiments, the second insulating member may be in substantially an entire region of the second wall.

According to one or more embodiments, the rivet terminal may include a rivet head portion on the terminal plate, and a rivet body portion penetrating the first through-hole of the case body, the first insulating member, and the terminal plate and protruding toward the outer surface of the first wall.

According to one or more embodiments, a thickness of one region of the terminal plate where the rivet head portion is located may be thicker than a thickness of another region of the terminal plate.

According to one or more embodiments, the case may further include a gasket between a side wall of the first through-hole of the case body and the electrode terminal, the rivet terminal being inserted into the gasket to insulate the case body from the electrode terminal and to insulate the rivet terminal from the case body.

According to one or more embodiments, the first insulating member may include a second through-hole corresponding to the first through-hole, and the gasket may be between side walls of the first through-hole and the second through-hole, and between the outer surface of the first wall of the case body and the electrode terminal in an axial direction of the first through-hole.

According to one or more embodiments, the case body may be made of a metal including stainless steel (SUS).

According to one or more embodiments of the present disclosure, a secondary battery may include an electrode assembly that includes a first electrode including a first electrode tab, a second electrode including a second electrode tab, and a separator, a case that has one opened surface configured to accommodate the electrode assembly, and a cover that covers the one opened surface of the case and seals the electrode assembly. The case may include a case body having a through-hole in a first wall of the case body, a first insulating member on an inner surface of the first wall, a terminal plate on the first insulating member and connected to the first electrode tab, a rivet terminal penetrating the through-hole of the case body, the first insulating member, and the terminal plate, and an electrode terminal connected to the rivet terminal on an outer surface of the first wall. The first insulating member may include a horizontal portion on the inner surface of the first wall, and a first extension portion extending from one side of the horizontal portion.

According to one or more embodiments, the first extension portion may extend in a direction substantially parallel to a second wall substantially perpendicular to the first wall.

According to one or more embodiments, the first extension portion may be higher than a height of the first electrode tab connected to the terminal plate.

According to one or more embodiments, the first insulating member may further include a second extension portion extending toward the cover from one side of the first extension portion.

According to one or more embodiments, the second extension portion may be on the first electrode tab.

According to one or more embodiments, the secondary battery may further include a second insulating member between the first insulating member and a second wall of the case body facing the cover.

According to some embodiments of the present disclosure, the first insulating member on the first wall inside the case may extend by being bent substantially parallel to the second wall substantially perpendicular to the first wall, and thus an electrical short circuit can be prevented (or at least mitigated) from occurring between the electrode tab connected to the terminal plate and the case.

According to some embodiments of the present disclosure, the second insulating member may be on the second wall of the case, and thus an electrical short circuit can be prevented (or at least mitigated) from occurring between the electrode tab and the case.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 is a perspective view illustrating a case according to one embodiment of the present disclosure.

FIG. 2 is a perspective view illustrating an opened side of the case according to one embodiment of the present disclosure.

FIG. 3 is an enlarged view of a region A of FIG. 2.

FIG. 4 is a diagram illustrating a cross-section taken along line B-B of FIG. 3.

FIG. 5 is a diagram illustrating a cross-section taken along line C-C of FIG. 3.

FIG. 6 is a diagram illustrating another embodiment of the case illustrated in FIG. 5.

FIG. 7 is a diagram illustrating another embodiment of the case illustrated in FIG. 5.

FIG. 8 is a perspective view illustrating one opened side of the case illustrated in FIG. 7.

FIG. 9 is a perspective view illustrating another embodiment of the case illustrated in FIG. 8.

FIGS. 10 to 15 are diagrams illustrating a secondary battery and a procedure of manufacturing the secondary battery according to one embodiment of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section.

Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein.

Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed”between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

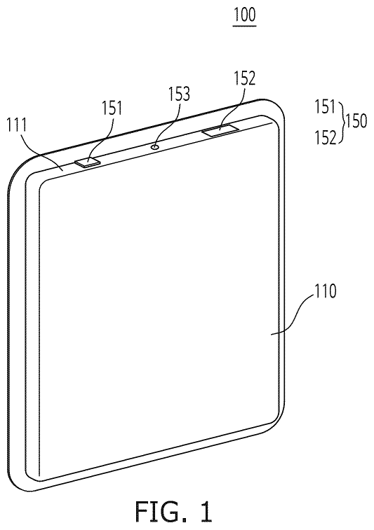

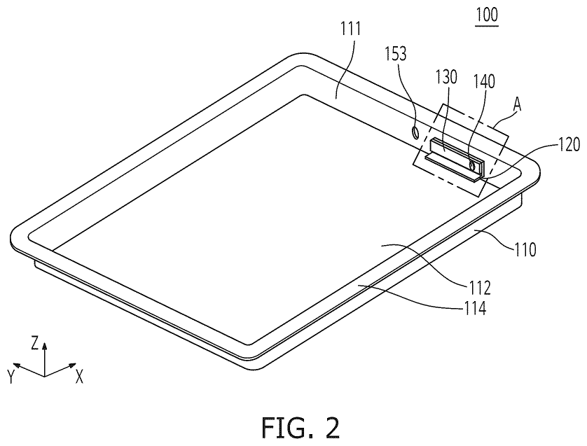

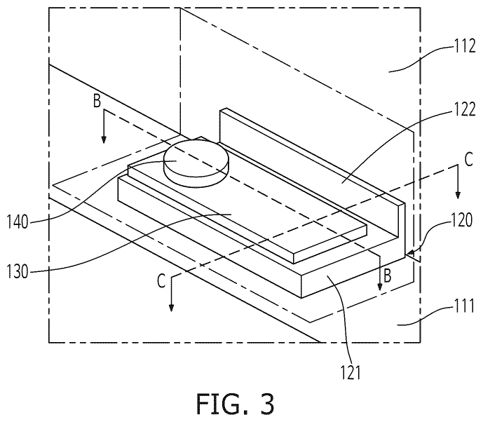

FIG. 1 is a perspective view illustrating a case 100 according to one embodiment of the present disclosure. FIG. 2 is a perspective view illustrating an opened side of the case 100 according to one embodiment of the present disclosure. FIG. 3 is an enlarged view of a region A of FIG. 2.

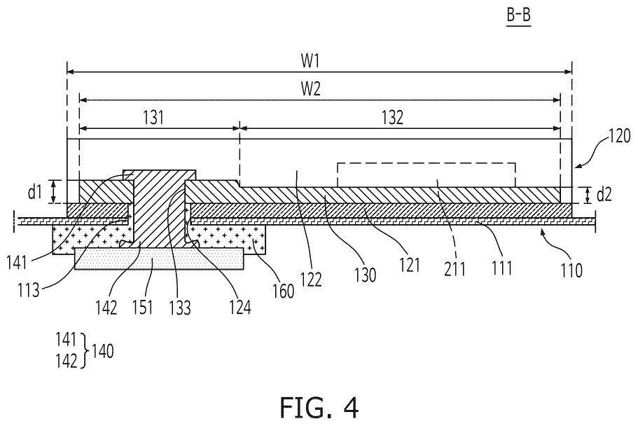

Referring to FIGS. 1 to 3, the case 100 according to one embodiment of the present disclosure may include a case body 110, a first insulating member 120, a terminal plate 130, a rivet terminal 140, a gasket 160 (see FIG. 4), a first electrode terminal 151, a second electrode terminal 152, and an electrolyte inlet 153.

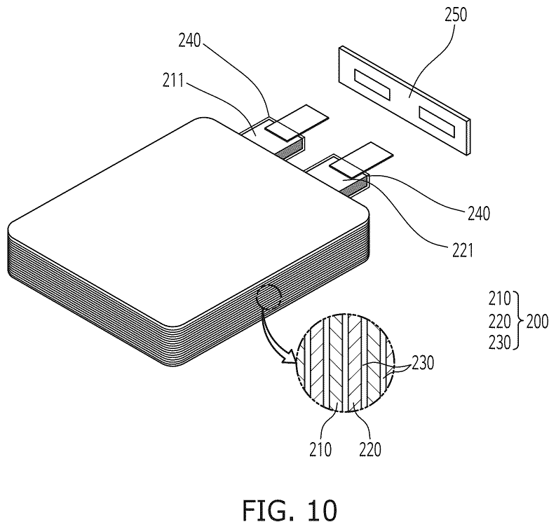

The case body 110 may form an overall exterior of the case 100. The case body 110 may have one opened surface to provide an accommodation space. The case body 110 may have one opened surface. For example, the case body 110 may include the accommodation space configured to accommodate an electrode assembly 200 (see FIG. 10) and a flange 114 formed along a periphery (e.g., a circumference) of the one opened surface. After the electrode assembly 200 is accommodated in the case 100, the flange 114 may be welded along the periphery while in contact with a cover 300. However, the case body 110 may have one or more opened surfaces or may have the cover 300 in a folding configuration, and the cover 300 may cover the case body 110 after the electrode assembly 200 is accommodated. The structure of the case body 110 is not limited herein.

The case body 110 may be made of (or include) a metal, such as stainless steel (SUS). In other embodiments, the case body 110 may be made of a conductive metal such as aluminum, an aluminum alloy, or nickel-plated steel. A thickness of the case 100 may be, but is not limited to, in a range from approximately 0.05 mm to approximately 0.3 mm.

A first through-hole 113 (see FIG. 4) may be in a first wall 111 of the case body 110. The electrolyte inlet 153 may be in the first wall 111 of the case body 110. The first insulating member 120 and the terminal plate 130 may be on an inner surface of the first wall 111 of the case body 110 (e.g., an inner surface of the case 100). The first electrode terminal 151 and the second electrode terminal 152 may be on an outer surface of the first wall 111 of the case body 110 (e.g., an outer surface of the case 100). The rivet terminal 140 on the terminal plate 130 may be inserted into the first through-hole 113 and may be connected to the first electrode terminal 151.

The first insulating member 120 may include a horizontal portion 121 and a first extension portion 122. The horizontal portion 121 may be on the first wall 111 of the case body 110. The horizontal portion 121 may be on the inner surface of the first wall 111. The terminal plate 130 may be on the horizontal portion 121. The horizontal portion 121 may insulate the terminal plate 130 from the case 100. The first extension portion 122 may be bent from one side of the horizontal portion 121. The first extension portion 122 may extend by being bent from one side (e.g., one edge) of the horizontal portion 121 in a direction substantially parallel to a second wall 112 (e.g., a back wall or face) intersecting (e.g., substantially perpendicular to) the first wall 111. In one embodiment, the second side 112 may face the one opened surface of the case body 110.

The terminal plate 130 may be on the first insulating member 120. The terminal plate 130 may be on the horizontal portion 121 of the first insulating member 120. In one region of the terminal plate 130, the rivet terminal 140 may be connected to the first electrode terminal 151 by penetrating the terminal plate 130, the first insulating member 120, and the first through-hole 113 of the case body 110. In another region of the terminal plate 130, the terminal plate 130 and a first electrode tab 211 of a first electrode 210 may be connected, as will be described later. The first electrode 210 may be electrically connected to the first electrode terminal 151 through the first electrode tab 211, the terminal plate 130, and the rivet terminal 140.

The rivet terminal 140 may be connected to the first electrode terminal 151 by penetrating the terminal plate 130, the first insulating member 120, and the first through-hole 113 of the case body 110 in one region of the terminal plate 130. The terminal plate 130 and the first electrode terminal 151 may be electrically connected through the rivet terminal 140.

The first electrode terminal 151 may be on the outer surface of the first wall 111 of the case body 110. The first electrode terminal 151 may be on the first through-hole 113 of the case body 110. The first electrode terminal 151 may be connected to the rivet terminal 140 inserted into the first through-hole 113. The first electrode terminal 151 may be electrically connected to the terminal plate 130 through the rivet terminal 140.

The first electrode terminal 151 may be insulated from the case body 110. The gasket 160 may be between the first electrode terminal 151 and the case body 110, and thus, the first electrode terminal 151 and the case body 110 may be insulated from each other.

The second electrode terminal 152 may be on the outer surface of the first wall 111 of the case body 110. The second electrode terminal 152 may contact the case 100. Because the case 100 may be damaged by welding in a procedure of being connected to an external device by welding, the second electrode terminal 152 (which has welding rigidity) may be attached to the case 100.

The electrolyte inlet 153 may be between the first electrode terminal 151 and the second electrode terminal 152, but the present disclosure is not limited thereto. The electrolyte inlet 153 may be in any region of the first wall 111 or on another wall of the case body 110. The electrolyte inlet 153 may be sealed by a sealing member after an electrolyte is injected into the interior of the case body 110.

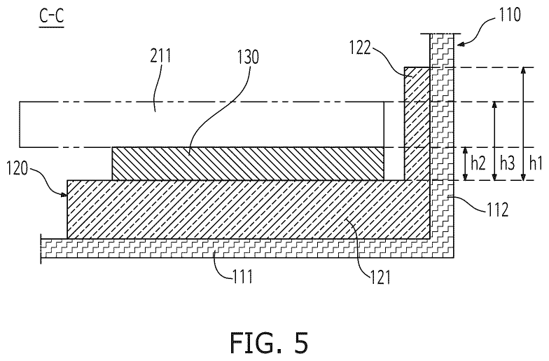

FIG. 4 is a diagram illustrating a cross-section taken along line B-B of FIG. 3. FIG. 5 is a diagram illustrating a cross-section taken along line C-C of FIG. 3.

Referring to FIG. 4, the first insulating member 120 and the terminal plate 130 may be on an inner surface of the first wall 111 of the case body 110. The first wall 111 may be an upper wall of the case body 110.

A second through-hole 124 may be in the first insulating member 120 and a third through-hole 133 may be in the terminal plate 130 to correspond to the first through-hole 113 in the first wall 111 of the case body 110. The rivet terminal 140 may extend through the first, second, and third through-holes 113, 124, and 133 on the terminal plate 130. The rivet terminal 140 may extend through the first, second, and third through-holes 113, 124, and 133 and may protrude from an outer surface of the first wall 111 of the case body 110.

The first electrode terminal 151 may be connected to the rivet terminal 140. The first electrode terminal 151 may be connected to the rivet terminal 140 protruding from the outer surface of the first wall 111 of the case body 110. The gasket 160 may be between the first electrode terminal 151 and the case body 110.

The first insulating member 120 may include the horizontal portion 121 and the first extension portion 122. The horizontal portion 121 may contact with the first surface 111 of the case body 110. The first extension portion 122 may extend parallel to the second wall 112 of the case body 110 that is substantially perpendicular to the first surface 111 by being bent from one side of the horizontal portion 121.

The terminal plate 130 may be on the first insulating member 120. A width W1 of the first insulating member 120 may be substantially equal to or longer than a width W2 of the terminal plate 130 in a direction corresponding to a long side (a lengthwise direction) of the first wall 111. As a result of the width W1 of the first insulating member 120 being longer than the width W2 of the terminal plate 130, both side surfaces of the first insulating member 120 may extend beyond the corresponding side surfaces of the terminal plate 130 such that an electrical short circuit does not occur between the case body 110 and both side surfaces of the terminal plate 130.

The terminal plate 130 may be connected to the first electrode tab 211. In a procedure of accommodating the electrode assembly 200 in the case 100, the first electrode tab 211 may be connected (coupled) to the terminal plate 130 by welding.

The rivet terminal 140 may be on the terminal plate 130. A thickness d1 of one region 131 of the terminal plate 130 where the rivet terminal 140 is located may be thicker than a thickness d2 of another region 132 of the terminal plate 130, as shown in FIG. 4. Because the case body 110 may be prone to damage in a procedure of crimping the rivet terminal 140, the thickness d1 of the one region 131 of the terminal plate 130 where the rivet terminal 140 is located may be thicker than the thickness d2 of another region 132 of the terminal plate 130 wherein the rivet terminal 140 is not located.

The rivet terminal 140 may include a rivet head portion 141 and a rivet body portion 142 extending from the rivet head portion 141. The rivet head portion 141 may be on the terminal plate 130. The rivet head portion 141 may receive pressure from a crimping device in the procedure of crimping the rivet terminal 140. The rivet body portion 142 may penetrate the first through-hole 113 of the case body 110 and may protrude to the outer surface of the first wall 111. The rivet body portion 142 may be inserted into the first, second, and third through-holes 113, 124, and 133 in the case body 110, the first insulating member 120, and the terminal plate 130, respectively, and may protrude to the outer surface of the first wall 111. The rivet body portion 142 protruding from the outer surface of the first wall 111 may be connected to the first electrode terminal 151.

The gasket 160 may be on side walls of the first through-hole 113 and the second through-hole 124. The gasket 160 may be between the outer surface of the first wall 111 of the case body 110 and the first electrode terminal 151 in an axial direction of the first through-hole 113. The gasket 160 may be between the side walls of the first through-hole 113 and the second through-hole 124 and the rivet body 142 in a radial direction of the first through-hole 113 and the second through-hole 124. The gasket 160 may insulate the first electrode terminal 151 from the case body 110 and may insulate the rivet terminal 140 from the case body 110.

Referring to FIG. 5, the horizontal portion 121 of the first insulating member 120 may be on the first wall 111 of the case body 110. The horizontal portion 121 of the first insulating member 120 may be on the inner surface of the first wall 111. The first extension portion 122 of the first insulating member 120 may extend from (and be bent relative to) one side of the horizontal portion 121 in the direction parallel (or substantially parallel) to the second wall 112 that is perpendicular (or substantially perpendicular) to the first wall 111.

The terminal plate 130 may be on the horizontal portion 121 of the first insulating member 120. The first electrode tab 211 may be connected on the terminal plate 130. A length of the horizontal portion 121 may be substantially equal to or longer than a length of the terminal plate 130 in a direction corresponding to a short side (a widthwise direction) of the first wall 111.

A height h1 at which the first extension portion 122 extends from the horizontal portion 121 may be higher than a height h2 at which the terminal plate 130 is on the horizontal portion 121. The height h1 at which the first extension portion 122 extends from the horizontal portion 121 may be higher than a height h3 of the first electrode tab 211 connected to the terminal plate 130. For example, in one or more embodiments, the extended height h1 of the first extension portion 122 may be in a range from approximately 100 μm to approximately 2 mm higher than the height h3 of the first electrode tab 211, but the present disclosure is not limited thereto.

As a result, in a procedure of connecting the terminal plate 130 and the first electrode tab 211 by welding, because the first electrode tab 211 and the second surface 112 of the case body 110 come into contact to cause an electrical short circuit, the height h1 of the first extension portion 122 extending parallel to the second surface 112 may be higher than the height h3 of the first electrode tab 211 connected to the terminal plate 130.

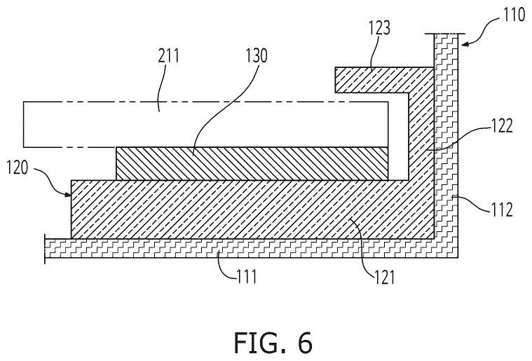

FIG. 6 is a diagram illustrating another embodiment of the case illustrated in FIG. 5.

Referring to FIG. 6, the first insulating member 120 may further include a second extension portion 123.

The second extension portion 123 may extend (and be bent from) one side of the first extension portion 122 in a direction intersecting (e.g., perpendicular to) a direction in which the first extension portion 122 extends. In one embodiment, the direction intersecting the direction in which the first extension portion 122 extends may be a direction toward the one opened surface of the case body 110.

The second extension portion 123 may extend from one side of the first extension portion 122 and on the first electrode tab 211 connected to the terminal plate 130. The second extension portion 123 may be spaced apart from the horizontal portion 121. The terminal plate 130 and the first electrode tab 211 may be between the horizontal portion 121 and the second extension portion 123.

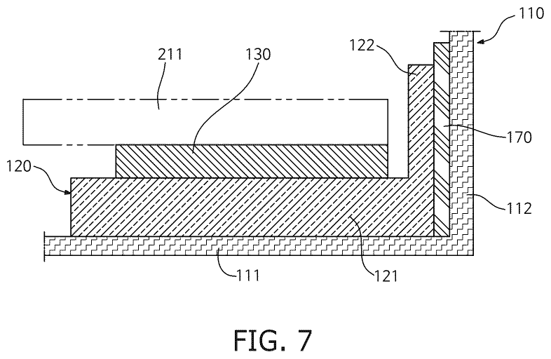

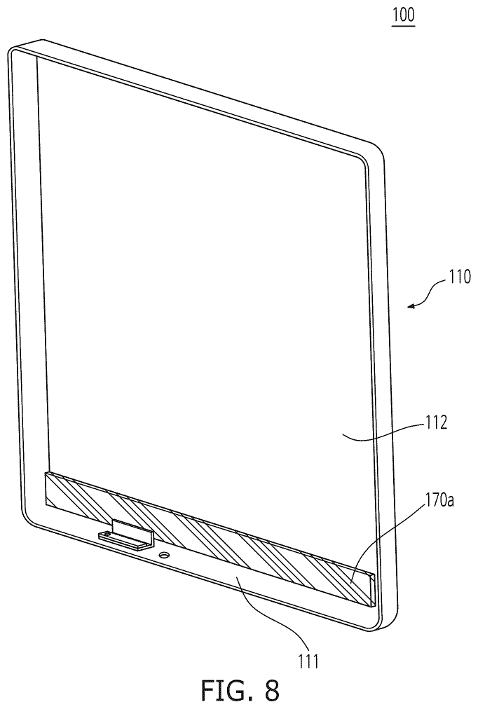

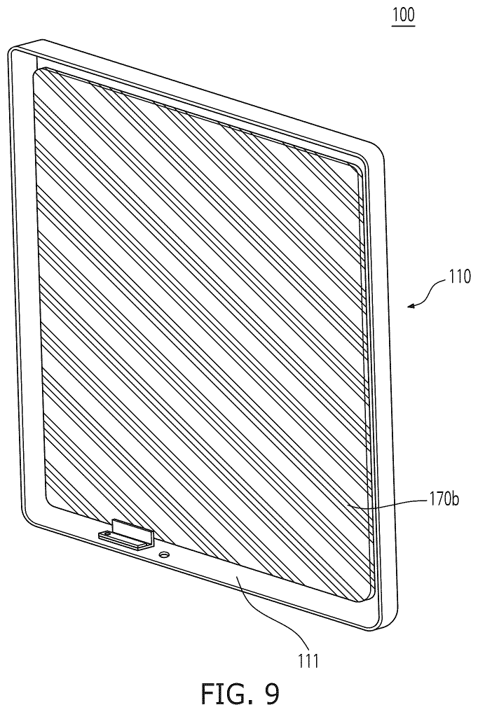

FIG. 7 is a diagram illustrating another embodiment of the case 100 illustrated in FIG. 5. FIG. 8 is a perspective view illustrating the one opened side of the case 100 illustrated in FIG. 7. FIG. 9 is a perspective view illustrating another embodiment of the case 100 illustrated in FIG. 8.

Referring to FIGS. 7 to 9, the case 100 may further include a second insulating member 170 (e.g., 170a or 170b). The second insulating member 170 may be between the first insulating member 120 and the second wall 112 of the case body 110 that is perpendicular (or substantially perpendicular) to the first wall 111. The second insulating member 170 may be attached to the second wall 112 including an insulating tape or may be coated on the second wall 112 including a coating base material, but the present disclosure is not limited thereto.

In one embodiment, as illustrated in FIG. 8, the second insulating member 170a may be in one region of the second wall 112. The second insulating member 170a may be in a region adjacent to the first insulating member 120. For example, in one or more embodiments, the second insulating member 170a may have a length corresponding to a length of the long side (a lengthwise direction) of the first wall 111 in a region adjacent to the first insulating member 120 on the second wall 112. In another embodiment, as illustrated in FIG. 9, the second insulating member 170b may be in the entire (or substantially the entire) region of the second wall 112.

However, the present disclosure is not limited to these embodiments, and in a procedure of accommodating the electrode assembly 200 in the case 100, the second insulating member 170 may be in any region requiring insulation between the electrode assembly 200 and the case 100.

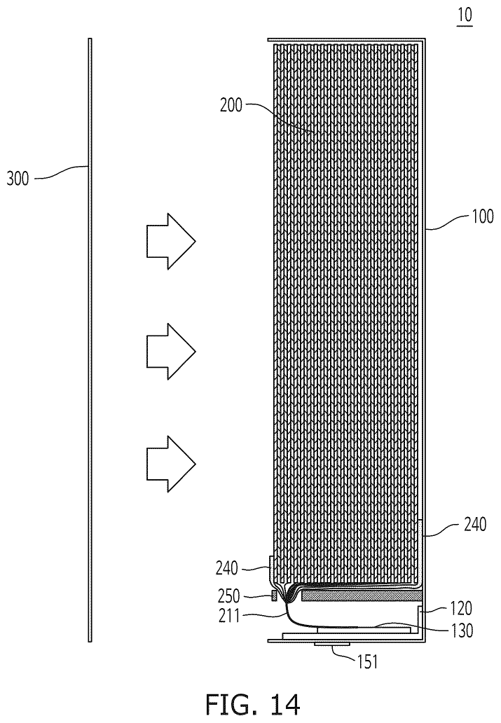

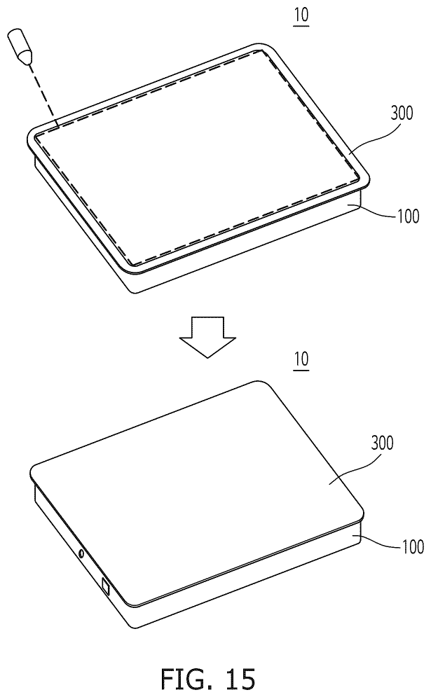

FIGS. 10 to 15 are diagrams illustrating a secondary battery and a procedure of manufacturing the secondary battery according to one embodiment of the present disclosure.

Referring to FIGS. 10 to 15, a secondary battery 10 according to one embodiment of the present disclosure may include an electrode assembly 200, a case 100 having one opened surface to accommodate the electrode assembly 200, and a cover 300 that covers the one opened surface of the case 100 to seal the electrode assembly 200 inside the case 100.

Referring to FIG. 10, the electrode assembly 200 may include a first electrode 210 including a first electrode tab 211, a second electrode 220 including a second electrode tab 221, and a separator 230 between the first electrode 210 and the second electrode 220. In one embodiment, the first electrode 210 may be a positive electrode, and the second electrode tab 221 may be a negative electrode. For example, the electrode assembly 200 may be a wound electrode assembly 200 formed by being wound with the separator 230, which is an insulator, between the first electrode 210 and the second electrode 220. In another example, the electrode assembly 200 may be a stacked electrode assembly 200 formed in a structure in which the first electrode 210 and the second electrode tab 221 are alternately stacked with the separator 230 interposed therebetween, or the electrode assembly 200 may be any structure including the first electrode 210 and the second electrode 220. The structure of the electrode assembly 200 described above is merely an example, and the present disclosure is not limited thereto.

The first electrode tab 211 may be formed separately and connected to an uncoated portion of the first electrode 210, or the first electrode tab 211 may be formed by punching out a part of the uncoated portion of the first electrode 210. The first electrode tab 211 may extend from the uncoated portion and contact the terminal plate 130. The second electrode tab 221 may be formed separately and connected to an uncoated portion of the second electrode tab 221, or the second electrode tab 221 may be formed by punching out a part of the uncoated portion of the second electrode 220. The second electrode tab 221 may extend from the uncoated portion and contact the case 100.

Insulating tapes 240 may be attached to the first electrode tab 211 and the second electrode tab 221. The insulating tapes 240 may insulate the case 100 in a procedure of bending the first electrode tab 211 and the second electrode tab 221, or the insulating tapes 240 may insulate the first electrode tab 211 and the second electrode tab 221 having different polarities from each other.

A third insulating member 250 may include a first through-hole and a second through-hole. The first electrode tab 211 and the second electrode tab 221 may be inserted into the first through-hole and the second through-hole, respectively, and thus the third insulating member 250 may be positioned on the electrode assembly 200.

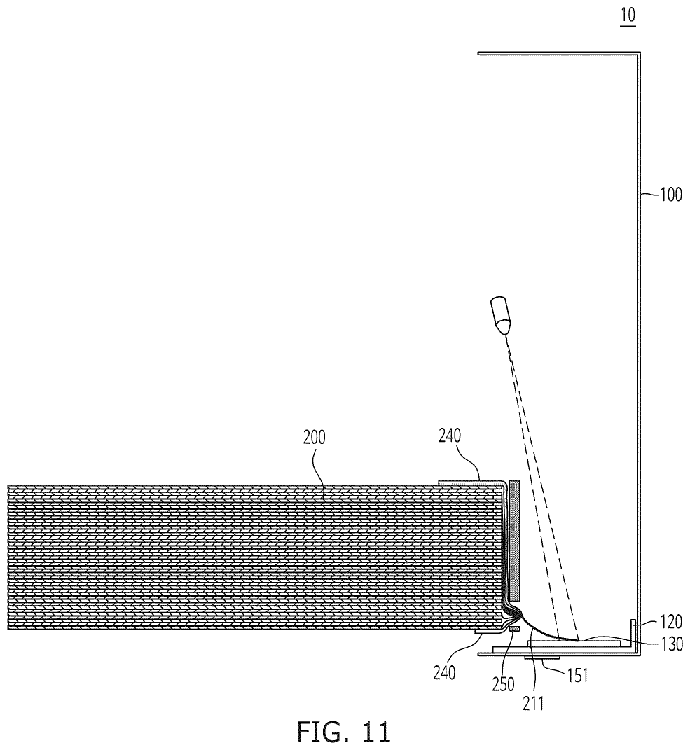

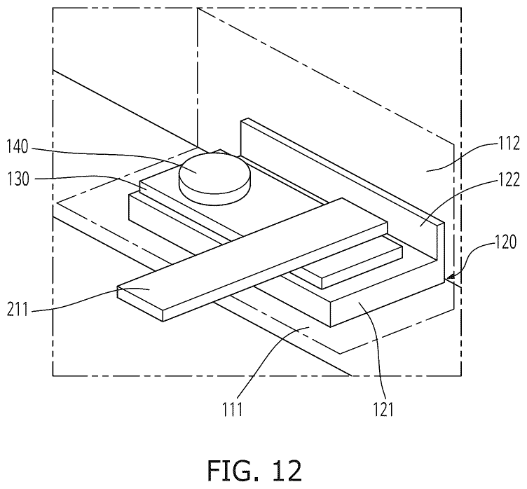

Referring to FIGS. 11 and 12, one surface of the case 100 may be opened, and the terminal plate 130 and the first electrode tab 211 may be welded to each other. In one embodiment, the case 100 may have substantially the same configuration as the case 100 described with reference to FIGS. 1 to 9, and thus the description of the configuration of the case 100 is omitted and not repeated below.

A first insulating member 120 may be on the case 100, for example, a first surface 111 of a case body 110. The first insulating member 120 may include a horizontal portion 121 on the first wall 111 and a first extension portion 122 extending parallel (or substantially parallel) to a second wall 112 perpendicular (or substantially perpendicular) to the first wall 111 from an edge of the horizontal portion 121. The terminal plate 130 may be on the first insulating member 120. On the terminal plate 130, the first electrode tab 211 may be connected (coupled) to the terminal plate 130. For example, in one or more embodiments, the first electrode tab 211 may be connected to the terminal plate 130 by welding. A height of the first extension portion 122 of the first insulating member 120 may be higher than a height of the first electrode tab 211 connected on the terminal plate 130.

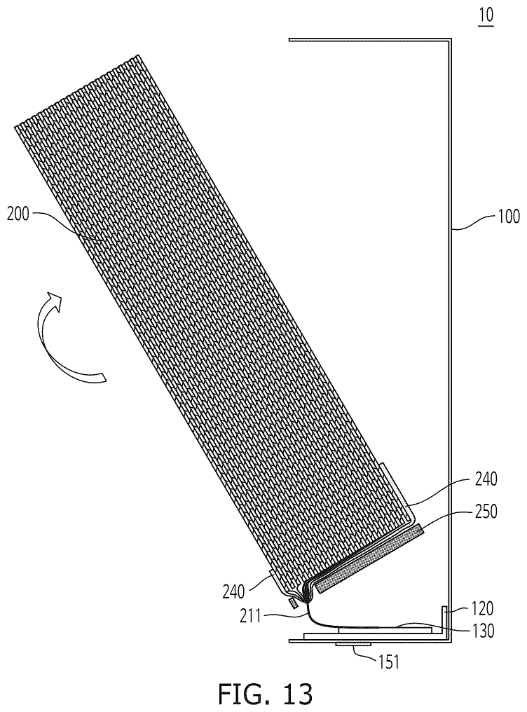

Referring to FIGS. 13 to 15, after the first electrode tab 211 and the terminal plate 130 are connected to each other, the electrode assembly 200 may be accommodated in the case 100 while bending the first electrode tab 211.

The cover 300 may seal the electrode assembly 200 from the outside and cover the one opened surface of the case 100. The cover 300 may be welded to the case 100 to seal the electrode assembly 200 from the outside. The cover 300 may be welded to a flange 114 of the case 100, and the cover 300 and the case 100 may be cut and ground along a welding line. Accordingly, the secondary battery 10 may be provided.

The case 100 for the secondary battery 10 described above and the secondary battery 10 including the case 10 are configured to prevent (or at least mitigate) an electrical short circuit between the electrode tab 211 and the case 100 in the procedure of accommodating the electrode assembly 200 in case 100 by providing the first insulating member 120 on the first wall 111 inside the case 100 and the second wall 112 perpendicular (or substantially perpendicular) to the first wall 111.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

### DESCRIPTION OF SYMBOLS

10: secondary battery 100: case
110: case body 111: first surface
112: second surface 120: first insulating member
130: terminal plate 140: rivet terminal
151: first electrode terminal 152: second electrode terminal
160: gasket 170: second insulating member
200: electrode assembly 210: first electrode
220: second electrode 211: first electrode tab
240: insulating tape 250: third insulating member
300: cover

What is claimed is:

1. A case comprising:
a case body comprising an accommodation space and a first through-hole in a first wall of the case body;
a first insulating member on an inner surface of the first wall;
a terminal plate on the first insulating member;
a rivet terminal penetrating the first through-hole of the case body, the first insulating member, and the terminal plate; and
an electrode terminal coupled to the rivet terminal on an outer surface of the first wall,
wherein the first insulating member comprises:
a horizontal portion on the inner surface of the first wall; and
a first extension portion extending from one side of the horizontal portion.

2. The case as claimed in claim 1, wherein the first extension portion extends in a direction substantially parallel to a second wall substantially perpendicular to the first wall.

3. The case as claimed in claim 1, wherein the first extension portion extends higher than a height at which the terminal plate is on the horizontal portion.

4. The case as claimed in claim 3, wherein the first extension portion extends higher than a height of an electrode tab connected to the terminal plate.

5. The case as claimed in claim 1, wherein the first insulating member further comprises a second extension portion that extends from one side of the first extension portion in a direction intersecting a direction in which the first extension portion extends.

6. The case as claimed in claim 1, wherein a width of the first insulating member is longer than a width of the terminal plate in a direction corresponding to a long side of the first wall.

7. The case as claimed in claim 1, further comprising:
a second insulating member between the first insulating member and a second wall of the case body, the second wall being substantially perpendicular to the first wall.

8. The case as claimed in claim 7, wherein the second insulating member is in one region of the second wall.

9. The case as claimed in claim 7, wherein the second insulating member is in substantially an entire region of the second wall.

10. The case as claimed in claim 1, wherein the rivet terminal comprises:
a rivet head portion on the terminal plate; and
a rivet body portion penetrating the first through-hole of the case body, the first insulating member, and the terminal plate and protruding toward an outer surface of the first wall.

11. The case as claimed in claim 10, wherein a thickness of one region of the terminal plate where the rivet head portion is located is thicker than a thickness of another region of the terminal plate.

12. The case as claimed in claim 1, further comprising:
a gasket between a side wall of the first through-hole in the case body and the electrode terminal, the rivet terminal extending into the gasket to insulate the case body from the electrode terminal and to insulate the rivet terminal from the case body.

13. The case as claimed in claim 12,
wherein the first insulating member comprises a second through-hole corresponding to the first through-hole, and
wherein the gasket is between side walls of the first through-hole and the second through-hole, and between the outer surface of the first wall of the case body and the electrode terminal in an axial direction of the first through-hole.

14. The case as claimed in claim 1, wherein the case body is made of a metal comprising stainless steel (SUS).

15. A secondary battery comprising:
an electrode assembly comprising a first electrode comprising a first electrode tab, a second electrode comprising a second electrode tab, and a separator;
a case comprising one opened surface configured to accommodate the electrode assembly; and
a cover covering the one opened surface of the case and sealing the electrode assembly in the case,
wherein the case comprises:
a case body comprising a through-hole in a first wall;
a first insulating member on an inner surface of the first wall;
a terminal plate on the first insulating member and connected to the first electrode tab;
a rivet terminal penetrating the through-hole of the case body, the first insulating member, and the terminal plate; and
an electrode terminal connected to the rivet terminal on an outer surface of the first wall, and
wherein the first insulating member comprises:
a horizontal portion on the inner surface of the first wall; and
a first extension portion extending from one side of the horizontal portion.

16. The secondary battery as claimed in claim 15, wherein the first extension portion extends in a direction substantially parallel to a second wall substantially perpendicular to the first wall.

17. The secondary battery as claimed in claim 15, wherein the first extension portion extends to be higher than a height of the first electrode tab connected to the terminal plate.

18. The secondary battery as claimed in claim 15, wherein the first insulating member further comprises a second extension portion extending toward the cover from one side of the first extension portion.

19. The secondary battery as claimed in claim 18, wherein the second extension portion is on the first electrode tab.

20. The secondary battery as claimed in claim 15, further comprising:
a second insulating member between the first insulating member and a second wall of the case body facing the cover.
